(19) United States
(12) Patent Application Publication
(10) Pub. No.: US 2001/0015016 A1
(43) Pub. Date: Aug. 23, 2001

(54) SHAVING HEAD AND SHAVING APPRATUS COMPRISING THE SHAVING HEAD

(75) Inventor: JOHAN PRAGT, DRACHTEN (NL)

Correspondence Address: CORPORATE PATENT COUNSEL, PHILIPS ELECTRONICS NORTH AMERICA CORP, 580 WHITE PLAINS ROAD, TARRYTOWN, NY, 10591

(73) Assignee: U.S. PHILIPS CORPORATION

(21) Appl. No.: 09/331,505

(22) PCT Filed: Dec. 18, 1997
(86) PCT No.: PCT/IB97/01580

§ 371 Date: None

(30) Foreign Application Priority Data
Dec. 23, 1996 (EP) 96203695.0

(51) Int. Cl. B26B 21/44

(52) U.S. Cl. 30/34.2; 30/41

(57) ABSTRACT

The invention relates to a shaving apparatus (9) comprising a basic part (8) and a shaving head (1). In use the shaving head (1) is pressed against a skin surface (3) and is pulled over the skin surface (3) in a shaving direction (y). The shaving head (1) comprises a cutter (5) having a cutting edge (6) which extends in a tangential direction (x) transverse to the shaving direction (y). The shaving head (1) further comprises a manipulator (10) adapted to move hairs engaging with the cutting edge (6) with respect to the shaving head (1) in a direction parallel to the tangential direction (x). The shaving head (1) is adapted to move the manipulator (10) to and fro. The basic part (8) comprises a drive system (30) for driving the manipulator (10) in the tangential direction (x).

The invention relates to a shaving head comprising a cutter having a cutting edge for cutting hairs near the skin and a manipulator adapted to move a hair along the cutting edge.

Such a shaving head is known from U.S. Pat. No. 2,568,047. The known shaving head comprises a cutter having a cutting edge for cutting hairs near the skin and a roller with V-shaped ribs on its periphery. Each rib extends circumferentially around the roller and substantially one-half of its circumference is inclined longitudinally in one direction of the axis of the roller and the other half of its circumference is oppositely inclined. The roller, while it is rotated by the skin during a cutting stroke, is shifted longitudinally of the cutting edge by an abutment which is fixed to the shaving head and has a terminal which extends between two ribs. The longitudinally moving roller moves the skin and the hairs along the cutting edge.

It is an object of the invention to provide a shaving head and shaving apparatus with an improved shaving result in comparison with the known shaving head. To this end the shaving head according to the invention is characterised in that the manipulator is adapted to move the hair relative to the skin while the hair is being cut by the cutting edge.

The load on a hair root depends on the force exerted on the hair by the shaving head. In this respect a distinction is to be made between shear-type shaving heads by which a hair is snipped off and knife-type shaving heads by which a hair is sliced off.

When a shear-type shaving head is used a hair is clamped between two edges which are movable relative to one another and which are subsequently moved towards one another, thereby subjecting the hair to shearing. Each of the edges exerts a substantial force on the hair but these forces are directed oppositely, as a result of which the shaving head exerts substantially no resultant force on the hair and the hair root is subjected to hardly any load.

When a knife-type shaving head is used a hair is severed in that a sharp edge exerts a force on the hair, without the hair being supported by the shaving head. When such a shaving head is used the force exerted on a hair by the shaving head is at least equal to the force required to move the cutting edge of the razor blade through the hair. This force is comparatively large, as a result of which a substantial load is exerted on the hair root.

The shaving head in accordance with the invention is a knife-type shaving head in which a movement of the hairs relative to the skin along the cutting edge is performed during cutting. As a result of this, the force required on a hair to move the cutting edge through the hair is comparatively small and the load to which the hair root is subjected is substantially smaller.

With the shaving head in accordance with the invention the hairs move past the cutting edge with a higher speed than the skin so that there is a difference between the cutting action of the cutting edge with respect to the skin and the cutting action of the cutting edge with respect to the hairs. This is because at skin level hairs are movable relative to the skin. Factors such as the implantation of the hairs in the skin, the viscoelasticity of the skin and the frequency with which the hairs are moved can play a part, individually but also in different combinations. Owing to said difference in speed, the load exerted on the hair roots is reduced without an increased risk of skin injury.

The measures in accordance with the invention also ensure that during shaving the forces exerted on the cutting edge by the hairs in a direction transverse to the cutting edge are substantially smaller than with the known shaving head, which reduces the likelihood of deformation of the cutting edge. Moreover, a hair is brought into contact with different parts of the cutting edge, as a result of which the forces spread over a larger part of the cutting edge. This results in a more uniform wear of the cutting edge. In addition, a less sharp cutting edge yet provides satisfactory shaving results owing to the improved cutting action.

It is to be noted that U.S. Pat. No. 4,118,863 discloses a hair trimmer having a movable blade and a stationary blade. Both blades have teeth to sever hairs caught between a tooth of the movable blade and a tooth of the stationary blade.

U.S. Pat. No. 4,159,566 discloses a razor comb intended for hair styling by the individual. The known razor comb comprises a razor having a cutting edge and covered at both sides by a comb attachment. Different comb attachments of different lengths can be fitted to trim the hair at different lengths. The razor is drivable by an electric drive mechanism in a direction parallel to the cutting edge. The relative speeds of the razor with respect to the hairs and the skin are in principle equal.

An embodiment of the shaving head in accordance with the invention is characterized in that the manipulator is adapted to move hairs to and fro along the cutting edge. By means of this measure it is achieved, inter alia, that the range of movement of the hair relative to the skin is traversed several times during cutting of the hair, thereby enhancing the afore-mentioned effects.

An embodiment of the shaving head in accordance with the invention is characterized in that the shaving head comprises a supporting surface for supporting the shaving head on the skin, the shaving head comprises a frame, and the manipulator is movable relative to the frame in a tangential direction along the cutting edge. This embodiment has the advantage that the shaving head can be of simple construction. The hairs can be moved along the cutting edge by moving the manipulator in the tangential direction and bringing the manipulator into contact with the hairs.

An embodiment of the shaving head in accordance with the invention is characterized in that the manipulator has recesses which extend near the cutting edge. A hair caught in one of the recesses will be moved in the tangential direction to some degree. Since the recesses extend near the cutting edge, for example disposed just underneath the cutting edge viewed from the supporting surface, the hair will perform a movement in the tangential direction at the instant that it contacts the cutting edge. The manipulator can be constructed, for example, as a foil provided with the recesses.

An embodiment of the shaving head in accordance with the invention is characterized in that in the tangential direction the recesses have a width between 100 and 400 micrometers. It has been found that in this range an optimum performance of the shaving head in accordance with the invention is achieved for regular hair thicknesses.

An embodiment of the shaving head in accordance with the invention is characterized in that the recesses are formed between teeth. As a result of the position of the teeth, hairs which engage with the cutting edge will at least partly come into contact with one or more teeth which move in the tangential direction. During this contact the manipulator and the relevant hairs interengage properly, as a result of which the hairs, when in contact, follow the movement of the manipulator and the relative speed of the hairs with respect to the cutter is equal to the relative speed of the manipulator with respect to the cutter.

An embodiment of the shaving head in accordance with the invention is characterized in that the distance between the ends of the teeth and the cutting edge lies between 50 and 1000 micrometers. The teeth should not be too short because otherwise the hairs will not be moved along in the tangential direction. Besides, in the case of too long teeth the hairs tend to disengage from between the teeth, after which they are flattened onto the skin by the teeth and are not severed or not severed properly. It has been found that the hairs are severed properly when the dimensions are as mentioned above.

An embodiment of the shaving head in accordance with the invention is characterized in that at the location of the cutting edge the teeth have a height smaller than 500 micrometers measured in a direction transverse to the supporting surface. It has been found that owing to this measure the hairs are less likely to remain caught between the teeth, which counteracts clogging of the recesses between teeth.

An embodiment of the shaving head in accordance with the invention is characterized in that the manipulator is movable relative to the frame in a direction transverse to the tangential direction. By means of this measure it is achieved that the friction in the tangential direction between the manipulator and the skin is reduced, as a result of which the skin moves less along the cutting edge and, consequently, the risk of nicking of the skin is reduced. Moreover, this measure promotes the removal of hair cuttings.

An embodiment of the shaving head in accordance with the invention is characterized in that the cutting edge is disposed at the level of the supporting surface and the manipulator forms at least a part of the supporting surface. As a result of this, hairs which project only slightly from the skin surface are also moved, so that even the roots of very short hairs are subjected to hardly any load. In addition, the cutter and the manipulator act at the level of the skin surface, as a result of which a smooth shave is obtained.

An embodiment of the shaving head in accordance with the invention is characterized in that the shaving head is adapted to provide a weak transmission between the manipulator and the skin. A weak transmission between the manipulator and the skin ensures that the manipulator movement is transmitted to the skin to only a small extent, which reduces the risk of the skin being nicked.

An embodiment of the shaving head in accordance with the invention is characterized in that the manipulator is movable in a direction transverse to the supporting surface. First of all, this reduces the transmission between the manipulator and the skin. Secondly, it ensures that the skin is effectively held at some distance from the cutting edge, which reduces the risk of nicking of the skin. The reduction of this transmission ensures that the manipulator movement transmitted to the skin is weak, as a result of which the skin is less likely to be moved in the tangential direction relative to the cutter and, consequently, the risk of nicking of the skin is reduced.

An embodiment of the shaving head in accordance with the invention is characterized in that at its side which faces the supporting surface the manipulator comprises a material which provides a low coefficient of friction with respect to the skin surface. For example, a Teflon coating or any other coating which provides a low friction between the manipulator and a skin is suitable for this purpose. Alternatively, the manipulator can be made wholly or partly of a material having a low coefficient of friction with respect to a skin.

An embodiment of the shaving head in accordance with the invention is characterized in that the cutter and the manipulator are flexible in a direction transverse to the supporting surface. By means of this measure it is achieved that the shaving head is capable of following contours of the skin to some extent, as a result of which less shaving movements are required.

An embodiment of the shaving head in accordance with the invention is characterized in that the cutting edge has a serrated structure with serrations smaller than 100 micrometers. Such a knurled structure further facilitates the severing of hairs. This measure is particularly suited for use in the shaving head in accordance with the invention because the hairs are moved in the tangential direction with respect to the cutting edge while the skin is hardly moved in the tangential direction with respect to the cutting edge, as a result of which the risk of skin injury is small.

The invention also relates to a shaving apparatus having a shaving head in accordance with the invention and a drive system for driving the manipulator. By means of such a shaving apparatus the advantages as described above are obtained.

An embodiment of the shaving apparatus in accordance with the invention is characterized in that the drive system is adapted to move the manipulator to and fro in the tangential direction. As a result of this step, the hairs are moved to and fro, so that the range of movement of the hair relative to the skin is traversed several times during cutting of the hair and the force required to move the cutting edge through the hair is thus further reduced.

An embodiment of the shaving apparatus in accordance with the invention is characterized in that the drive system is adapted to drive the manipulator with an amplitude of 50 to 250 micrometers in the tangential direction. If the amplitude is too small it appears that the hairs are not moved adequately. If the amplitude is too large the hairs slip out of the recesses. It has been found that in said range satisfactory shaving results and a high shaving comfort are obtained.

An embodiment of the shaving apparatus in accordance with the invention is characterized in that the drive system is adapted to drive the manipulator with a frequency higher than or equal to 100 Hz. It has been found that satisfactory results are obtained already at 100 Hz. The viscoelasticity of the human skin is such that the skin appears to be less compliant for frequencies above 30 Hz, so that it can be moved less easily and the risk of nicking of the skin is further reduced at higher frequencies. Moreover, it has been found that at 100 Hz and a normal speed of movement of the shaving head over the skin the manipulator moves a hair to and fro about ten times during cutting. At a frequency higher than 100 Hz the results improve because the cutting performance improves further with the same amplitude of the manipulator. Besides, the shaving head can be moved more rapidly over the skin at a higher frequency, yielding the same result and comfort.

An embodiment of the shaving apparatus in accordance with the invention is characterized in that the drive system comprises a piezoelectric element. A piezoelectric element is particularly suitable for driving because the manipulator need only be moved with a small amplitude. Owing to this measure less space is required for the drive system and more freedom is obtained for an aesthetically pleasing design of the shaver.

An embodiment of the shaving apparatus in accordance with the invention is characterized in that the mass of the oscillating parts is more than 10 times as small as the mass of the shaving apparatus. This precludes a movement of the cutter relative to the skin in the tangential direction as a result of reaction forces. Preferably, the shaving apparatus comprises a counter-mass which is moved oppositely to the manipulator in order to counteract reaction forces on the cutter.

The invention also relates to a shaving apparatus comprising a shaving head in accordance with the invention and an applicator for applying an agent to the skin, which agent reduces the transmission between the manipulator and the skin. By means of this measure it is achieved that when the shaving head is repeatedly moved over a part of the skin this part of the skin can each time be provided with a film of the agent. Thus, with such a repeated application, the transmission between the skin and the manipulator is kept under control, thereby minimizing the risk of skin injury. Even if the agent is water, this provides a substantial reduction of the transmission between the skin and the manipulator because the water forms a film between the manipulator and the skin. In addition, special emulsions or water containing friction-reducing and or skin-care additives may further improve the shaving comfort.

An embodiment of the shaving apparatus in accordance with the invention is characterized in that the applicator comprises a porous structure. Owing to this measure the skin can be moistened by briefly holding the applicator, for example while attached to the apparatus, under the tap before and, if desired, during shaving. The applicator absorbs water when held under the tap and it releases the water again when brought into contact with the skin owing to the capillary action of the spaces between the applicator and the skin.

An embodiment of the shaving apparatus in accordance with the invention is characterized in that the agent comprises a substance which can be taken up by water and which is stored in the porous structure. This substance may include skin-care additives which further improve the shaving comfort.

An embodiment of the shaving apparatus in accordance with the invention is characterized in that the applicator takes the form of a roller. Owing to this measure the applicator can roll over the skin during shaving so that the applicator does not hook behind stubbles and each time another part of the applicator comes into contact with the skin.

An embodiment of the shaving apparatus in accordance with the invention is characterized in that said applicator comprises a reservoir for holding said agent and further comprises dispenser means for applying the agent to the skin in a controlled amount. This measure enables an agent in liquid form or in powder form to be applied to the skin during shaving. The dispenser means may comprise, for example, a pump or a controllable valve.

The invention will now be described in more detail, by way of example, with reference to the drawings, in which

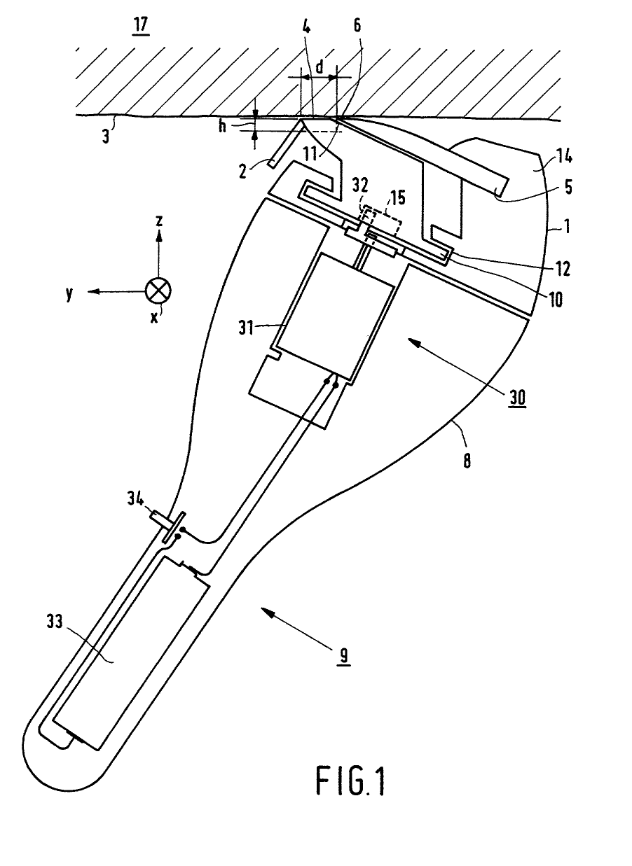

FIG. 1 is a diagrammatical side view of a first embodiment of the shaving apparatus in accordance with the invention,

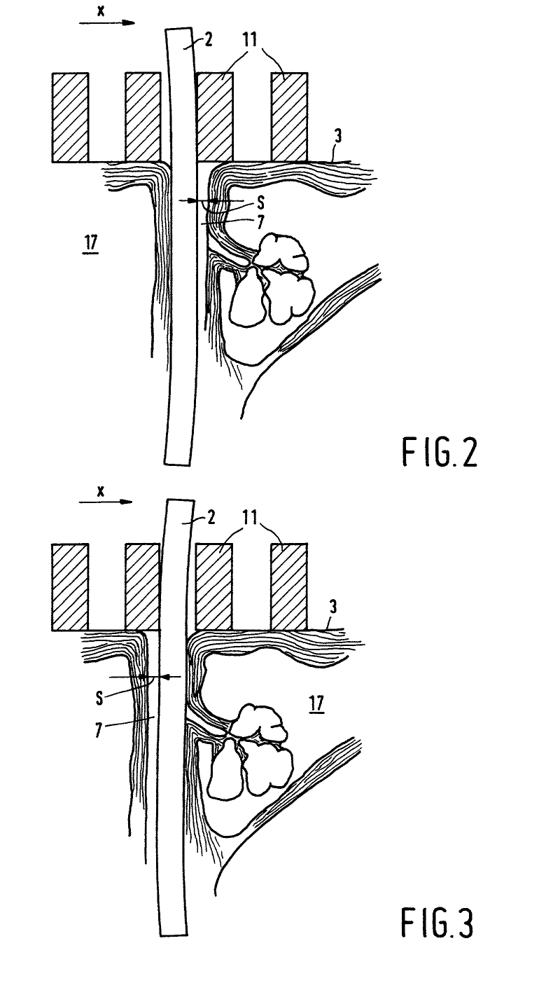

FIG. 2 and FIG. 3 are sectional views showing a hair and the cooperation of the shaving head in accordance with the invention with the hair,

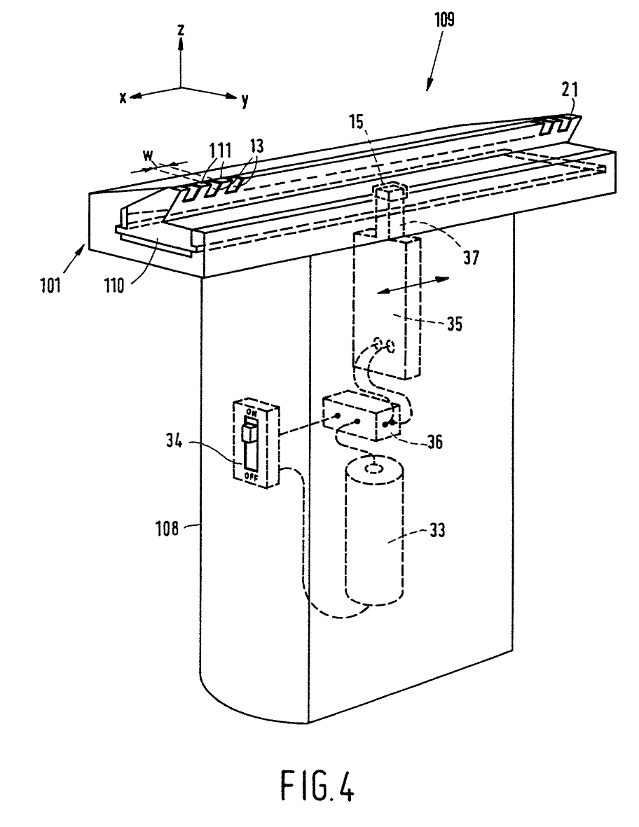

FIG. 4 is a perspective view showing a second embodiment of the shaving apparatus in accordance with the invention,

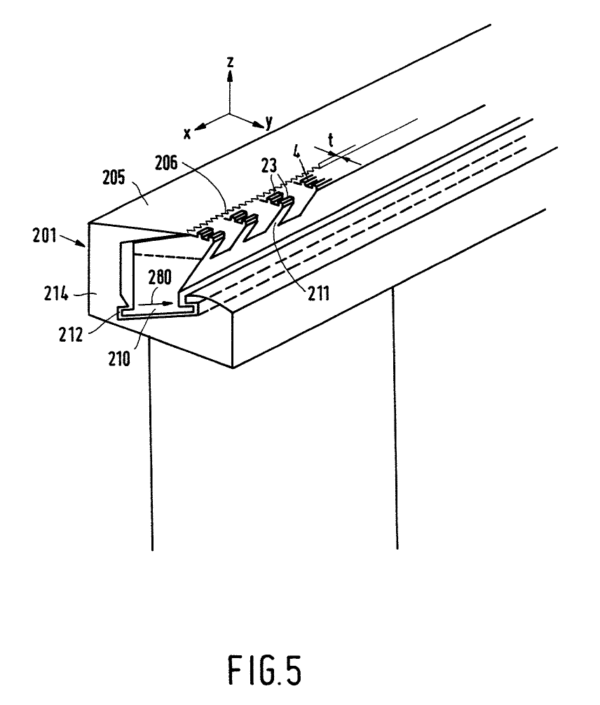

FIG. 5 shows a part of a second embodiment of the shaving head in accordance with the invention,

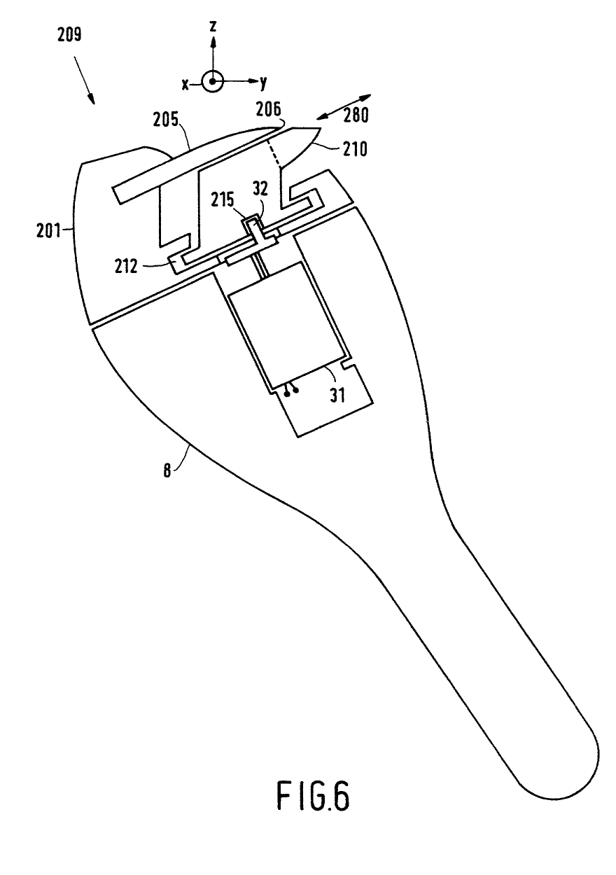

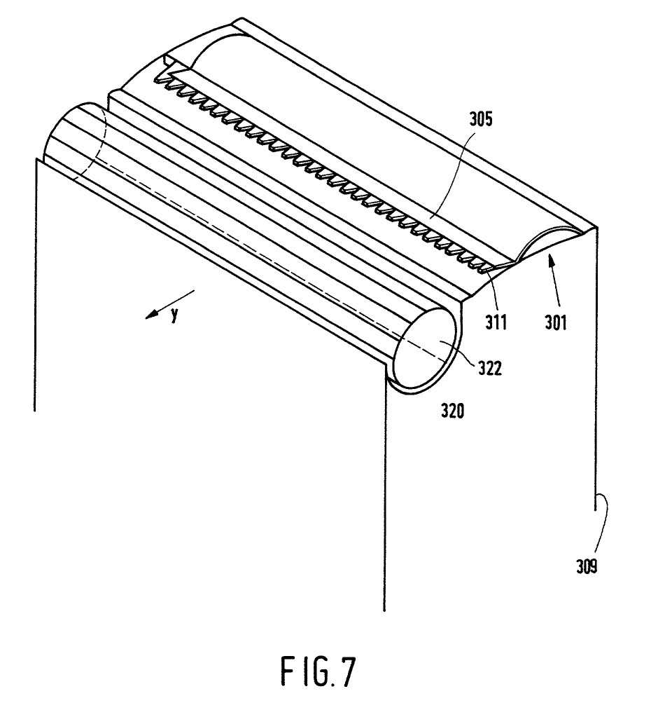

FIG. 6 shows diagrammatically a third embodiment of the shaving apparatus in accordance with the invention,

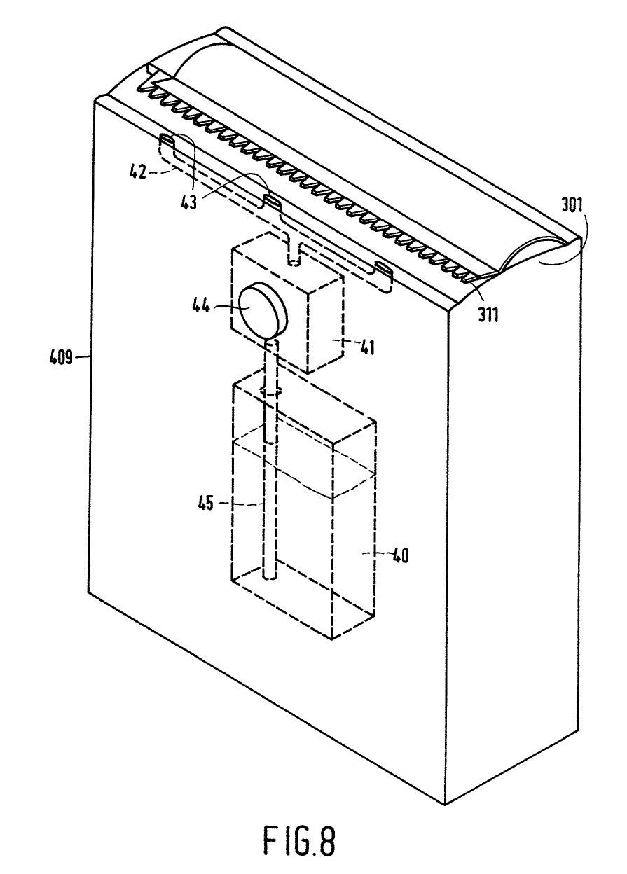

FIG. 7 is a perspective view showing a fourth embodiment of the shaving apparatus in accordance with the invention, and

FIG. 8 shows a fifth embodiment of the shaving apparatus in accordance with the invention.

FIG. 1 is a diagrammatic side view showing a first embodiment of the shaving apparatus in accordance with the invention. The shaving apparatus 9 comprises a basic part 8 and a shaving head 1 in accordance with the invention. In use the shaving head 1 is pressed against a skin surface 3 and is moved over the skin surface 3 in a shaving direction y. The shaving head 1 serves for severing a hair 2 rooted in the skin 17. The shaving head 1 comprises a frame 14 carrying a stationary cutter 5. The cutter 5 forms part of a supporting surface 4 for supporting the shaving head 1 on the skin surface 3. the cutter 5 has a cutting edge 6 which, in or near the supporting surface 4, extends in a tangential direction x transverse to the shaving direction y. The shaving head 1 further comprises a manipulator 10 adapted to move hairs which engage the cutting edge 6 relative to the shaving head 1 in a direction parallel to the tangential direction x. The manipulator 10 is movable relative to the cutter 5 in the tangential direction x. The manipulator 10 further has recess 13 (see FIG. 4), in the present case formed between teeth 11, for transmitting the movement of the manipulator 10 to the hair 2. The teeth 11 extend just before the cutting edge 6 in a direction transverse to the tangential direction x. The teeth 11 are so positioned that, as a result of the movement of the shaving head 1 in the shaving direction y, a hair 2 engages a recess 13 between two teeth 11 before it contact the cutting edge 6 of the cutter 5. The shaving head 1 is adapted to produce an oscillating movement of the manipulator 10 by means of a guide 12. The basic part 8 comprises a drive system 30 for driving the manipulator 10 in the tangential direction x. The drive system 30 is adapted to drive the manipulator 10 in a reciprocating fashion with a frequency of 100 Hz. For this purpose, the drive system 30 comprises an electric motor 31, which drives an eccentric 32. The eccentric 32 engages a groove 15 in the manipulator 10, which groove extends in the shaving direction y. In the tangential direction x the groove 15 accurately fits around the eccentric 32, so that a rotary movement of the eccentric 32 is converted into a reciprocating movement of the manipulator 10 in the tangential direction x. To power the motor 31 the basic part 8 comprises a battery 33 and a switch 34. Instead of the rotary motor 31 it is possible to use a vibramotor, in which case the eccentric 32 can be dispensed with.

In the embodiment of the shaving head in accordance with the invention shown in FIG. 1 the cutter 5 and the manipulator 10 each form part of the supporting surface 4. As a result of this, a hair 2 can be severed very close to the skin surface 3 and a very short hair can also be moved to and fro in the tangential direction x by the teeth 11 of the manipulator 10.

The teeth 11 are dimensioned in such a way that the distance d between the ends of the teeth 11 and the cutting edge 6, measured in the shaving direction y, is approximately 250 micrometers. At the location of the cutting edge 6 in the direction z transverse to the supporting surface 4 the teeth 11 have a dimension h of approximately 300 micrometers. Owing to these dimensions hair cuttings readily fall out of the gaps between the teeth 11 and clogging of the gaps between the teeth 11 is avoided. The teeth 11 and the cutter 5 are slightly flexible in the direction z, thereby enabling skin contours to be followed to some extent.

FIG. 2 and FIG. 3 both show a sectional view of a hair 2 in a follicle 7 in a skin 17. FIG. 2 shows the hair 2 in a position in which one of the teeth 11 has pressed the hair 2 in a direction opposite to the tangential direction x. The hair 2 is then wholly pressed against the left side of the follicle 7 in the skin 17. It is clearly visible that the hair 2 has a clearance s in the follicle 7.

FIG. 3 shows the hair 2 in a position in which the hair 2 is wholly pressed against the right-hand side of the follicle 7 in the skin 17 by one of the teeth 11. It has been found that the clearance s of the hair relative to the follicle 7 is of the order of magnitude of some hundreds of micrometers. As a result, the hair 2 can be moved to and fro by the teeth 11 with a comparatively high speed, while the skin 17 follows the movement of the hair 2 only partly or not at all. The latter depends particularly on the transmission between the teeth 11 and the skin surface 3 for movements in the tangential direction x. This transmission can also be produced via the hair 2. However, it has been found that if the drive system 30 (see FIG. 1) is adapted to drive the manipulator 10 with a frequency of 100 Hz and an amplitude between 50 and 250 micrometers in the tangential direction x, this yields a weak transmission.

FIG. 4 is a perspective view showing a second embodiment of the shaving apparatus in accordance with the invention. The shaving apparatus 109 comprises a shaving head 101. The shaving head 101 comprises a manipulator 110 having teeth 111, the distance w between the teeth 111 being approximately 250 micrometers. At their upper sides the teeth 111 have a coating 21 for reducing the friction between the skin surface 3 (see FIG. 1) and the manipulator 110. The shaving apparatus 109 comprises a basic part 108, which accommodates a drive system for driving the manipulator 110. The drive system comprises a piezoelectric element 35 driven by an oscillator 36. The oscillator 36 is energized by means of a battery 33 and a switch 34. At its lower side the piezoelectric element is secured (not shown) in the basic part 108 and at its upper side it has a projection 37 which engages a groove 15 in the manipulator 110 of the shaving head 101. When the oscillator 36 is energized the piezoelectric element 35 performs an oscillating movement in the tangential direction x. This oscillating movement is transmitted to the manipulator 110 via the projection 37 and the groove 15.

FIG. 5 is a perspective view showing a part of a second embodiment of the shaving head in accordance with the invention. The shaving head 201 comprise a frame 214, a manipulator 210 and a spacer, in the present case formed by ridges 23 for reducing the contact area between the manipulator 210 and the skin (not shown). The ridges 23 are situated on the teeth 211 and extend in the tangential direction x. The shaving head 201 further comprises a guide 212 for guiding the manipulator 210 relative to the shaving head 201. The guide 212 is such that the manipulator 210 is movable in the tangential direction x and is also movable in a direction 280 having a component in the shaving direction y and a component in the direction z transverse to the supporting surface 4. The cutter 205 has a cutting edge 206 with a serrated structure whose serrations are shown to a highly enlarged scale and have a dimension t of approximately 40 micrometers.

FIG. 6 shows diagrammatically a third embodiment of the shaving apparatus in accordance with the invention. The shaving apparatus 209 comprises a basic part 8 as shown in FIG. 1 and a shaving head 201 in accordance with the second embodiment of the invention as shown in FIG. 5. The manipulator 210 has a recess 215 which fits tightly around the eccentric 32. When the eccentric 32 is driven by a motor 31 the manipulator 210 follows the circular movement of the eccentric 32. As a result of this, the manipulator performs both a reciprocating movement in the tangential direction x and a reciprocating movement in the direction 280. The movement in the direction 280 has a component in the direction z, so that the skin is held effectively at some distance from the cutting edge 206. Moreover, this reduces the transmission between the manipulator 210 and the skin. The movement in the direction 280 also has a component in the shaving direction y. This promotes the removal of hair cuttings.

The mass of the manipulator 210 is approximately 20 times as small as the mass of the shaving apparatus 209. This counteracts a movement of the cutter 205 in the tangential direction x relative to the skin as a result of the reaction forces.

FIG. 7 is a perspective view of a fourth embodiment of the shaving apparatus in accordance with the invention. The shaving apparatus 309 comprises a shaving head 301 and an applicator for applying an agent to the skin during shaving. The shaving head 301 comprises a cutter 305 and a manipulator having teeth 311. The teeth 311 slightly converge towards their ends to promote the capture of hairs between the teeth 311. The shaving apparatus 309 comprises an applicator formed by a roller-shaped porous element 322 arranged in a recess 320 in the shaving apparatus 309. The roller 322 can be moistened by holding the shaving apparatus 309 in a water jet. Preferably, the roller 322 contains a substance which can be taken up by water and which has a friction-reducing and/or skin-care effect. By pulling the shaving head 301 over the skin in the shaving direction y the skin is moistened, as a result of which the transmission between the teeth 311 and the skin is reduced.

FIG. 8 shows a fifth embodiment of the shaving apparatus in accordance with the invention. The shaving apparatus 409 comprises a shaving head 301 as shown in FIG. 7. In addition, the shaving apparatus 409 comprises a reservoir 40 containing a liquid agent for reducing the transmission between the manipulator and the skin. The shaving apparatus 409 further comprises dispenser means, in the present case a pump 41 comprising a push-button 44, an inlet tube 45 and a dispenser channel 42. By regularly pressing the push-button 44 during shaving the agent is pumped from the reservoir 40 to outlet apertures 43 near the shaving head 301 via the dispenser channel 42. Thus, the skin is moistened with the agent and the transmission between the teeth 311 and the skin is reduced.

It is to be noted that the invention is not limited to the embodiments described hereinbefore. For example, instead of recesses the manipulator can have a surface with a high friction relative to the hairs. Alternatively, the manipulator can move the hairs by imparting vibrations to the skin or the air just above the skin. If desired, the hairs can be moved in the tangential direction by an electrostatic method. Moreover, it is conceivable to drive the manipulator by means of a roller which is applied to the skin and which is drivable by pulling the shaving apparatus over the skin. Furthermore, the shaving head can be adapted for use with an exchangeable cutter, so that a cutter can readily be replaced by a new cutter. Besides, the shaving head may comprise an adjustment mechanism to adjust the distance between the shaving head and the supporting surface.

1. A shaving head (1) comprising a cutter (5) having a cutting edge (6) for cutting hairs (2) near the skin (17) and a manipulator (10) adapted to move a hair along the cutting edge, characterized in that the manipulator is adapted to move the hair (2) relative to the skin while the hair is being cut by the cutting edge (6).

2. A shaving head (2) as claimed in claim 1, characterized in that the manipulator (10) is adapted to move hairs (2) to and fro along the cutting edge (6).

3. A shaving head (1) as claimed in any one of the preceding claims, characterized in that the shaving head comprises a supporting surface (4) for supporting the shaving head on the skin (17), the shaving head comprises a frame (14), and the manipulator (10) is movable relative to the frame (14) in a tangential direction (x) along the cutting edge (6).

4. A shaving head (101) as claimed in claim 3, characterized in that the manipulator has recesses (13) which extend near the cutting edge (6).

5. A shaving head (101) as claimed in claim 4, characterized in that in the tangential direction (x) the recesses (13) have a width (w) between 100 and 400 micrometers.

6. A shaving head (101) as claimed in claim 4 or 5, characterized in that the recesses (13) are formed between teeth (111).

7. A shaving head (101) as claimed in claim 6, characterized in that the distance (d) between the ends of the teeth (11) and the cutting edge (6) lies between 50 and 1000 micrometers.

8. A shaving head (1) as claimed in claim 6 or 7, characterized in that at the location of the cutting edge (6) the teeth (11) have a height (h) smaller than 500 micrometers measured in a direction (z) transverse to the supporting surface (4).

9. A shaving head (201) as claimed in any one of the preceding claims 3 to 8, characterized in that the manipulator (210) is movable relative to the frame (214) in a direction (280) transverse to the tangential direction (x).

10. A shaving head (1) as claimed in any one of the preceding claims 3 to 9, characterized in that the cutting edge (6) is disposed at the level of the supporting surface (4) and the manipulator (10) forms at least a part of the supporting surface.

11. A shaving head as claimed in any one of the preceding claims 3 to 10, characterized in that the shaving head is adapted to provide a weak transmission between the manipulator (10) and the skin (17).

12. A shaving head (201) as claimed in claim 11, characterized in that the manipulator (210) is movable in a direction (z) transverse to the supporting surface (4).

13. A shaving head (101) as claimed in claim 11 or 12, characterized in that at its side which faces the supporting surface (4) the manipulator (110) comprises a material (21) which provides a low coefficient of friction with respect to the skin surface (3).

14. A shaving head (1) as claimed in any one of the preceding claims 3 to 13, characterized in that the cutter (5) and the manipulator (10) are flexible in a direction transverse to the supporting surface (4).

15. A shaving head (201) as claimed in any one of the preceding claims, characterized in that the cutting edge (6) has a serrated structure (206) with serrations smaller than 100 micrometers.

16. A shaving apparatus comprising at least one shaving head (1) as claimed in any one of the preceding claims and a drive system (30) for driving the manipulator (10).

17. A shaving apparatus (9) as claimed in claim 16, characterized in that the drive system (30) is adapted to move the manipulator (10) to and fro in the tangential direction (x).

18. A shaving apparatus (9) as claimed in claim 17, characterized in that the drive system (30) is adapted to drive the manipulator (10) with an amplitude of 50 to 250 micrometers in the tangential direction (x).

19. A shaving apparatus (9) as claimed in claim 17 or 18, characterized in that the drive system (30) is adapted to drive the manipulator (10) with a frequency higher than or equal to 100 Hz.

20. A shaving apparatus (109) as claimed in claim 17, 18 or 19, characterized in that the drive system comprises a piezoelectric element (35).

21. A shaving apparatus (209) as claimed in claim 17, 18, 19 or 20, characterized in that the mass of the oscillating parts (210) is more than 10 times as small as the mass of the shaving apparatus.

22. A shaving apparatus (309; 409) as claimed in any one of the preceding claims 16 to 21, comprising an applicator (322; 40-44) for applying an agent to the skin, which agent reduces the transmission between the manipulator and the skin.

23. A shaving apparatus (309) as claimed in claim 22, characterized in that the applicator comprises a porous structure (322).

24. A shaving apparatus (309) as claimed in claim 23, characterized in that the agent comprises a substance which can be taken up by water and which is stored in the porous structure (322).

25. A shaving apparatus (309) as claimed in claim 23 or 24, characterized in that the applicator (322) takes the form of a roller.

26. A shaving apparatus (409) as claimed in claim 22, characterized in that said applicator comprises a reservoir (40) for holding said agent and further comprises dispenser means (41, 42) for applying the agent to the skin in a controlled amount.
